(19) United States
(12) Patent Application Publication
(10) Pub. No.: US 2020/0294052 A1
(43) Pub. Date: Sep. 17, 2020

(54) A method to make payments during the access of a vehicle inside payment areas

(71) Applicant: Progress Consultant S.r.l., Milano (IT)

(72) Inventor: Stefano Cacciami, Milano (IT)

(21) Appl. No.: 16/081,905

(22) PCT Filed: Oct. 12, 2016
(86) PCT No.: PCT/IB2016/056087

§ 371 Date: Sep. 1, 2018

(30) Foreign Application Priority Data
Mar. 11, 2016 (IT) 102016000026018

(51) Int. Cl. G06Q 20/40; G06K 9/32; G07B 15/00

(52) U.S. Cl. CPC G06Q 20/4014; G06K 9/325; G06K 2209/15; G06Q 2240/00; G07B 15/00

(57) ABSTRACT

A method of making a payment to have a vehicle access an area, or a section to be covered, requiring payment for admission includes the steps of memorizing, in a central server, an identification code associated to a vehicle, the identification code being a univocal distinctive element of the vehicle; at the moment of transit of the vehicle, obtaining one or more images through one or more cameras, prearranged to focus on the at univocal distinctive element of the vehicle; and receiving the univocal distinctive element at the central server and checking its presence in the memory of the central server, in order to proceed with a payment consensus.

### TECHNICAL FIELD OF THE INVENTION

The present invention refers to the technical field related to electronic instruments for making the payment following to the access of a vehicle inside an area which foresees a toll, such as payment parking, highways, etc.

In particular, the invention refers to an innovative method and related equipment, which allows a payment in a safe manner without the risk of frauds or malfunctioning.

### BACKGROUND ART

It is known that many parking areas or roads foresee a payment for parking or for travelling.

Therefore, garages and/or parking areas are known and they foresee generally a payment by collecting a parking slip which shows the entrance time. At the moment of exiting, the slip is inserted into a specific nozzle of a receiving machine which reads the entrance time and calculates the balance based on the exit time. Once paid the amount, the machine releases an exit slip which has to be inserted inside the specific prearranged nozzle in proximity of a rod which prevents from exiting. Once inserted the slip, the rod gets up and allows the exit of the vehicle.

Such payment system has, obviously, the technical inconvenience of being structurally complex, as it requires a machinery for the payment which has to release the slip for the exit, in addition to the further machinery which checks the opening/closing of the rod. Moreover, the payment procedure is rather arduous, as the user has to get out of the car and pay physically and then collect the exit slip. It is obvious that such procedure involves multiple inconveniences for the users, especially in case of rain and/or long queues to pay.

A similar system is also foreseen at highway tool booths, where the entrance slip has to be inserted, acquired at the entrance tool booth with a specific stop, inside a specific machinery which requires the equivalent amount in order to proceed with an opening consensus for exiting.

Nowadays the use of Telepass is widespread to solve said technical inconveniences. It is an electronic device which is placed inside a vehicle in visible position, generally on the front glass, in order to communicate with a reader on the access gate. Therefore, it is read by the specific reader in proximity of access gates of payment areas, in such a manner that all passages with their related tolls can be registered. Such Telepass is connected to the specific vehicle and the payment takes place directly through the bank once the account statement of the accesses is sent (generally once a month). Recently, the Telepass system has been used also to access to payment areas, as it is read while entering or exiting and the balance is obtained from it.

Such Telepass system, well known by now in the background art, solves numerous technical inconveniences, as it prevents the user from stopping the vehicle and even from getting out of it to make the payment.

However, the Telepass system has its own technical inconveniences too.

The Telepass reading system has not ever proved to be efficient and serviceable and it happens often to pass through it while thinking that the reader had been checking the Telepass device, but, instead no reading took place for a missing communication. This causes an irregular transit and the user often receives at home a fine or a request of payment.

The Telepass can also be easily removed from a mean of transportation (for example fraudulently) and used by an unauthorized user which uses it fraudulently on its own vehicle, thus charging the other subject.

In that case, the defrauded subject has to block the Telepass and report it and, in any case, he was subjected to a damage, in terms of money and waste of time for solving such problem.

In addition, the Telepass system works with a battery and so, as time passes by, it can run out of charge thus resulting useless until the battery is replaced and/or recharged.

Even associated to a vehicle, the Telepass system can also be used with plates that are not corresponding to the vehicle to which they are connected, thus allowing an illegal use.

Furthermore, its use is not allowed in different countries using a different technology.

### DISCLOSURE OF THE INVENTION

It is therefore the aim of the present invention to provide a method to solve at least in part said technical inconveniences.

In particular, it is the aim of the present invention to provide an innovative method which allows payment accesses with an own vehicle, with a convenient and fast payment system, without the risk of frauds or thefts.

It is also the aim of the present invention to provide an innovative method which allows payment accesses in an easy way independently from the country where the user is driving.

These and other aims are obtained with the present method to make a payment during the access of a vehicle inside a payment area or section, as per claim 1.

Such method comprises the operations of:

Memorization in a central server (2) of at least an identification code (C.I.) associated to at least one vehicle, said identification code being a univocal distinctive element (450) of the vehicle;

Arrangement of acquisition means of the images (100) in points (A′-B′, B′-C′, C′-D′) pre-established of said areas or sections to be covered, preferably points of access and/or exit, such as also intermediate points along said sections, and at the moment of the transit in access and/or exit of the vehicle from said points, acquisition of one or more images through said image acquisition means (100) arranged in such a way as to frame at least such an univocal distinctive element (450) of the vehicle;

Reception by the central server (2) of said univocal distinctive element (450) and check of the presence thereof in the memory.

In this way, all said technical inconveniences are solved.

In particular, the use of the Telepass is no more necessary, which, as already said, can run out of charge and stop working.

The described method can take advantage of simple cameras, possibly already in use, and as it is based on the acquisition of images, in particular of the plate of the vehicle, does not allow frauds.

In addition, the risk of malfunctioning due to the missed communication between the access and the Telepass cannot occur anymore, thus making the solution more reliable.

Advantageously, in case of check with positive result, the server orders a payment consensus.

Advantageously, even other distinctive elements of the vehicle could be used, the preferred configuration of the invention uses the plate of the vehicle, or a part of it.

Advantageously, depending on the cases, such image acquisition means (100) can be foreseen only in the access gate or in correspondence of the access gate and/or in intermediate points.

Advantageously, such acquisition means are univocally identified (for example with a code) in such a way as to allow to detect the specific geographic area where they are positioned.

For applying the correct charges it is in fact necessary to know where the transit images have been detected.

Advantageously, said image acquisition means are connected to a local server which is communicating with the central server.

In this way, the local server memorizes the images and sends them to the central server, possibly already elaborated (that is having already deduced the plate number).

Advantageously, a preliminary phase of connection to the central server (2) is foreseen to make the registration by inserting the identification code (C.I.) associated with the vehicle and that is kept in memory in the central server.

Advantageously, the system requires the insertion of a further authorization code (C.A.) associated to the identification code (C.I.).

Advantageously, following the phase of transit of the vehicle and reception by the central server (2) of said univocal distinctive element (450), a further phase is foreseen, preceding the payment authorization, in which the central server connects to an external device (1) sending a request for insertion of an authorization code (C.A.), preferably said external device being a mobile telephony device.

This solution protects from the risk of frauds, as the insertion of the authorization code and its check by the central server are required before the payment.

Advantageously, following the reception by the server of said authorization code (C.A.) the server checks the correctness of the code received, comparing it with the one in memory and, in case of positive result, proceeds with the payment consensus.

It is also here described an assembly for making a payment during the access of a vehicle to an area or section to be covered after payment, said assembly foreseeing:

A central server (2) suitable for receiving and memorizing at least one identification code (C.I.) associated to the vehicle, said identification code being a univocal distinctive element (450) of the vehicle;

Image acquisition means (100) designated for image acquisition (400) relative to said univocal distinctive element (450) of the vehicle;

The assembly being configured in such a way that said univocal distinctive element (450) of the vehicle, once acquired by the image acquisition means, is transmitted to the central server (2) which is programmed to check the presence of said distinctive element in its memory.

### BRIEF DESCRIPTION OF THE DRAWINGS

Further characteristics and advantages of the present method, and related device, according to the invention, will result more clearly with the following description of some embodiments, made to explain and not to limit, referring to the annex drawings, wherein:

FIG. 1 shows a mobile telephony device on which the software application is being downloaded, according to the present invention;

FIG. 2 and FIG. 3 show a central server 2 managing the process and requiring the insertion, for memorization, of the plate of the vehicle and an authorization code;

FIG. 4 shows the central server 2 wherein various plates with their related authorization code for each registered subject are being saved;

FIG. 5 shows an access of a vehicle inside a payment area and shows the collection of the image related to the plate of the vehicle;

FIG. 6, the flow chart of FIG. 7 and FIG. 8 describe the phases of operation.

### DESCRIPTION OF SOME PREFERRED EMBODIMENTS

The present invention concerns an innovative method, and related device, which allows to make payments of tolls (for example parking areas or highway transits) in safe and comfortable way, avoiding to run into frauds such as thefts or cloning of traditional devices, such as Telepass or similar ones.

According to the invention, a specific application “App” can be foreseen and it can be easily downloaded on every kind of device apt to make it work.

Therefore, the user can download such specific application, which can be installed on computers in general, such as laptops but more preferably mobile telephony devices such as widely used Smartphone or Iphones or equally, Tablets, Ipads, palmtops and similar ones.

Obviously, the use of a mobile telephony device, such as a Smartphone or an Iphone, is advantageous because they are commonly used, pocket-sized or anyway transportable devices, so they accompanying the user during the day. They are preset in such a manner to process data, download software applications that work in their operating system and connect rapidly to the internet.

FIG. 1 shows, not restrictively, a mobile telephony device on which such application is being downloaded, that requires initially a registration in such a manner that a central server 2 (which manages such software application) can save the data related to the specific subject that downloaded and is using the application itself.

The download method of a software application on devices in general, for example the above-mentioned mobile telephony devices, is background art and for this reason it is not described further.

As known, for downloading the application, it is possible to search it in the internet network through the own device and then to order a download operation with a network connection to the appointed server 2.

During the operation of the application, the device connects itself to the appointed server which manages its operation.

When the application is being installed, it requires the data insertion of the subject, in such a manner that they can be saved in the appointed server, that is the central server, by identifying univocally in respect to other potential subjects that join the service.

The application, for a better security, can require the insertion of a password in such a manner that the opening of the application itself and its launch, as it is described further, can always be bounded to the insertion of a preliminary access key and possibly allowing an access to a well-known reserved area.

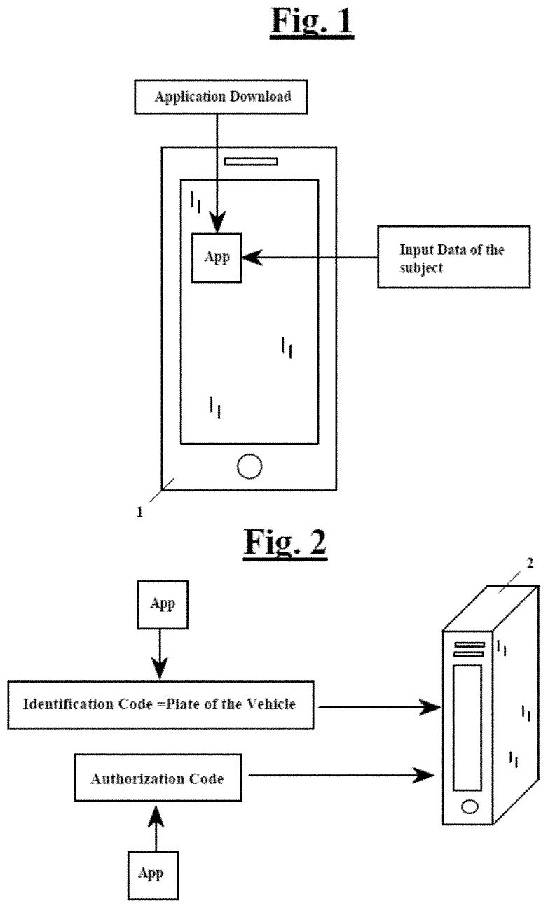

At this point, as shown in FIG. 2, the central server 2 which manages the application, requires the insertion of an identification code (C.I.) and preferably also an authorization code (C.A.) by the registering user.

In that case, the required identification code implies the insertion of a univocal identification data of the own vehicle in order to identify it through the image acquisition.

Such identification data is thus associated as C.I. of the specific subject.

In particular, in the preferred embodiment of the invention, the plate number of the vehicle (or part of it) is selected as C.I., as the plate is connected univocally to the specific vehicle (different vehicles with the same plate number cannot exist) and, moreover, it is easily obtainable through the images, as it will be explained clearly in the following description.

So, the plate defines univocally a vehicle and the subject owner of the vehicle itself.

Cameras are generally placed permanently in such a manner that they can always focus a wide area that includes the plate. However, it does not exclude as insertion also another distinctive element of the vehicle which is included in the acquisition area of the image.

Always as shown in FIG. 2, the application can require also the insertion, due to security reasons and as explained in the following description, of an authorization code C.A. which is connected to the specific object and so to the related C.I.

Such authorization code can be any alphanumeric, numeric, biometric, etc. code and can also be automatically assigned by the server and communicated to the user through said App.

Therefore, FIG. 2 outlines the case wherein the subject is making the access, signing up for the on-line service and inserting the plate number and its own authorization code in the specific fields.

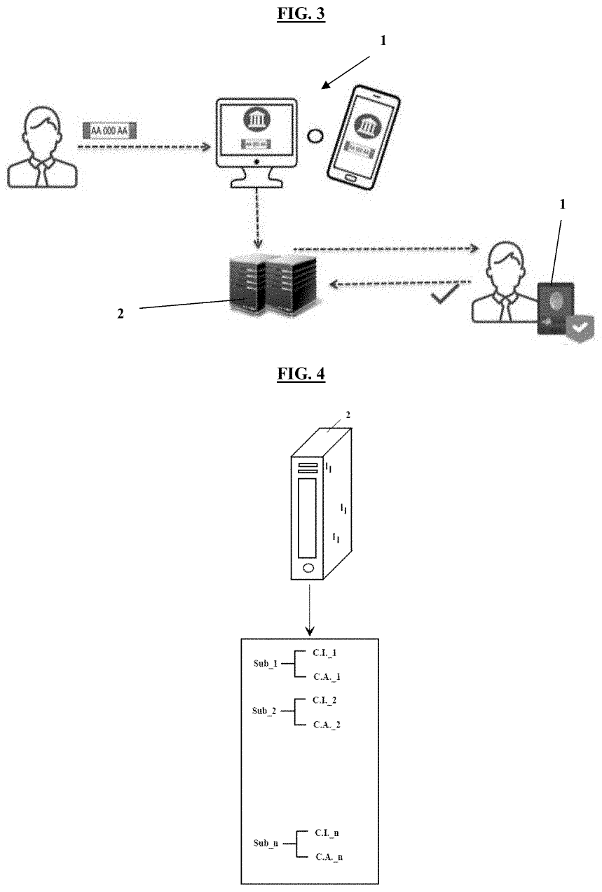

In an equivalent variation, as shown in FIG. 3, after the insertion of the plate number, the central server is asking the insertion of an authorization code (which is a fingerprint in the example of FIG. 3) to the user, through the device by which he made the access.

As shown in FIG. 4, the central server 2 has saved in its memory a related authorization code and a possible authorization code for each subject.

Going further with the structural description of the invention, it is then foreseen the use of acquisition means of the images 100, for example in the form of one or more cameras 100 that can be pre-established in each point where they are supposed to be necessary for the collection of data areas (for example access and/or exit points from payment areas and/or also in intermediate points of said sections).

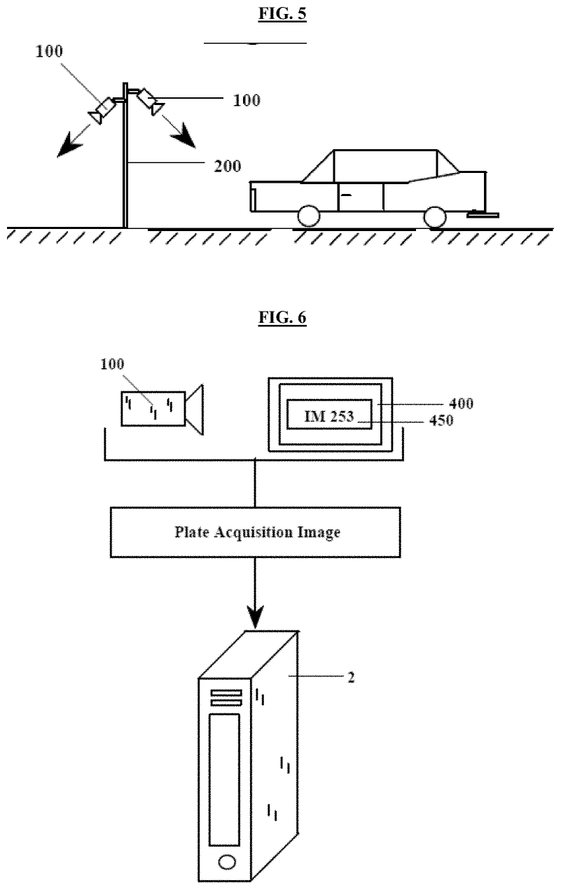

FIG. 5 shows, for example, a vehicle (a car) entering the gate 200 controlled by such cameras.

In a not limiting way, the gate 200 can be an access to a payment parking area, as also an access to a payment section (a highway—also known technically as “Concessionaire”).

According to the invention, cameras are prearranged in such position to collect an image related to the identification data of the vehicle, taken as C.I., in particular in the present configuration the plate or part of it.

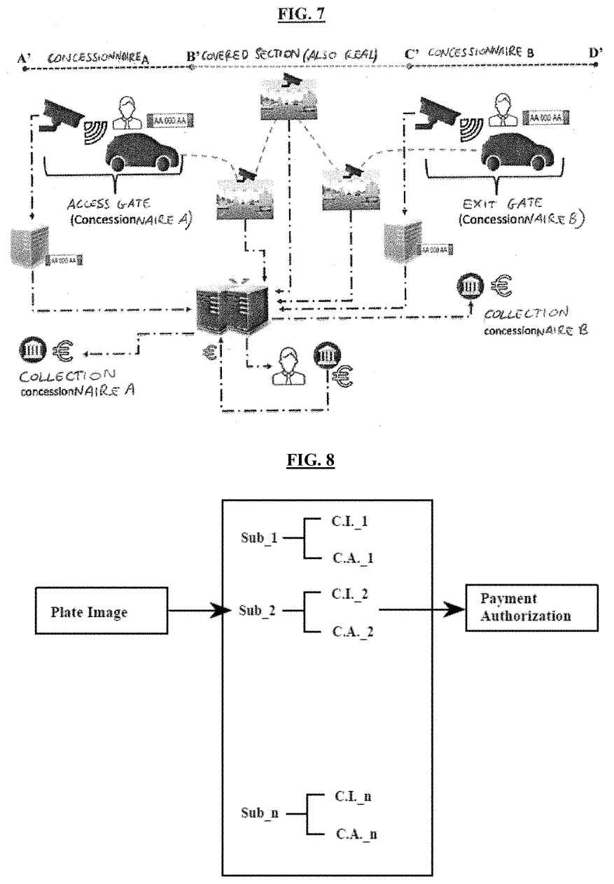

Therefore, FIG. 6 shows an image 400 focused by the camera 100 which includes the plate 450.

The camera is then put in communication with the central server 2 in such a manner to send the acquired image.

The communication can take place in various known ways, for example, the internet network.

Therefore, the camera can connect to a local server which communicates to the central server for sending the images.

Such solution is advantageous as all pre-existing cameras in general are connected to local servers for filing the images and current cameras collect only the image (that is they do not have any processor which elaborates the images to obtain data related to the contents). Therefore, it is necessary a server in general to elaborate/send images and, as already said, in this way local servers already foreseen for managing the pre-existing cameras can be used.

As alternative, the camera can be directly connected to such central server, if configured to transmit and possibly to elaborate such acquired images.

As alternative, the central server can be programmed itself to obtain, with known programs, the related contents and so the plate from the acquired image, in case of cameras configured to send such images.

Referring to FIG. 6, at this point the central server 2, through an elaboration of the image that can take place at the moment or before, has a plate number that can search on its own electronic list in memory, as per FIG. 8.

Therefore, the central server can, at this point, verify if such plate number is on its own list of users in memory.

In case of positive result, that is the presence of the C.I. and of the authorization code, the central server orders a payment for the subject owner of such identification code referring to the occurred transit.

In case of presence of the authorization code, it is inserted only once and the server, after having checked the congruence of the identification code, checks the presence in the memory of the related authorization code before giving the payment consensus.

Obviously, the authorization code is not essential and it can also be missing.

In fact, it is reminded that the subject has made a registration to the software service by giving the data, including also the bank reference or another system for making the payment.

At this point the server asks a payment, by connecting for example to the bank of the owner or by sending a payment request to the bank.

The flow chart of FIG. 7 shows in detail the working method of the present invention more precisely.

With the term “Concessionaire A” and “Concessionaire B” are marked the payment sections having an access and an exit, as also the intermediate section.

Therefore, the example refers specifically, to a distance in a payment road section defined by segments A′-B′, B′-C′, C′-D′ that are whatever lengths and subjected to whatever rate, also different one to the other.

In each access and exit point (so points A′, B′, C′, D′), cameras are foreseen: they acquire the image of the plate and send them to the central server (to be processed or already processed), in such a manner that the central server, as described, searches for such plate in its memory in order to allow the payment.

Having a camera at the access or exit gate is important for a toll whose amount depends on the peculiar type of covered distance. The server, by checking that the memorized plate (X) has covered a distance (A′-B′-C′), can request a related payment based on the foreseen amounts.

In other cases, for example in fixed amount tolls, only a camera at the access gate would be enough. The same could be applied to accesses of ferries or other payment boarding means of vehicles.

Cameras along the section could be foreseen, if the amount changes depending on a change of direction or on a covered part of the section.

The same architecture of FIG. 7 is usable for example in parking areas.

A picture at the access gate and at the exit gate allows to find out the parking time and so to the related balance.

It is obvious that, to calculate the due balances, it is necessary to identify the camera which sends the image in order to know univocally where it is placed geographically and so to which road section/parking it is referring. As a consequence, the price list applied to said section is deduced.

This architecture, as described, allows to solve said technical problems.

Obviously, in respect to traditional systems the user does not need to get out of the car anymore in order to pay and to collect the exit slip from specific machines.

In respect to the traditional solution with the Telepass, the system results now more functional and more safe.

In particular, the system for acquiring and sending images results certainly more safe compared to the reading system of the Telepass, which often gets stuck for a missing communication (in this case, while an image is being acquired, the communication between the Telepass and its reader is no more necessary).

In addition, the described system is for sure more safe from frauds. In particular, as already said, a Telepass system can be stolen and used by an unauthorized subject, with a bitter surprise for the person receiving the payment request on his bank account. The present solution solves such problem, as the payment is now related to the acquisition of a specific element of the vehicle and chosen as identification code. Therefore, there is no external device which can be stolen and used for fraudulent access payments.

Finally, there is no risk of malfunctioning due to the lack of charge of the Telepass battery (which has an average duration of five years).

The described method is working also with the identification code C.I. only and so without necessarily coupling and/or memorizing the authorization code C.A. in the central server.

However, the presence of an authorization code increases the security according to a further variation described below.

At the moment of the transit, the server searches the C.I. and, if it does not find it, it finds the subject owner exactly as described so far.

Differently from the first embodiment, the server connects with the user through the downloaded “App” and ask the insertion of the C.A. through its application to the user. It can take place immediately or subsequently.

Therefore, if the user passes through a payment access gate, for example the access of a ferry, the appointed camera acquires the image (for example the plate) and sends such images or the plate directly to the central server 2.

The central server checks if there is the plate (substantially it checks if the vehicle passing through the gate is registered to such service).

At this point, if it finds the plate and so the subject, it sends a request for inserting the C.A. to the subject. The subject inserts the authorization code through its own application and the server receiving such C.A. checks if it is correct, that is if it corresponds to the memorized code and so to that one designated by the user upon the registration and related to the identification code.

If it is congruent, so the server allows the payment as described, otherwise it does not allow the payment.

It is obvious that in all described cases the C.A. can also be selected by the server automatically and sent to the subject.

This variation of the invention increases the security as it prevents a spiteful person from registering to the service by inserting a fake plate and counterfeiting also the plate of his own vehicle, thus charging his transits to another unaware subject.

The presence of the password (that is the authorization code C.A.), and its following confirmation request by the server to the transiting user, avoids this risk, as, even the data related to the C.I. can correspond, the confirmation request of the C.A. makes each cloning effort difficult.

Such method can be applied for the access to every payment areas and also for the access to ships, trains, etc.

The invention claimed is:

1. A method of making a payment during access of a vehicle to an area, or a section to be covered, requiring paid admission, the method comprising:
memorizing, in a central server (2), at least an identification code (C.I.) associated to the vehicle, said identification code being a univocal distinctive element (450) of the vehicle;
arranging an acquisition device of images (100) in one or more points (A′-B′, B′-C′, C′-D′) that have been pre-established in said area or section to be covered; and,
when the vehicle transits to access and/or exit of from said one or more points, acquiring one or more images through said acquisition devices (100) arranged to frame at least said univocal distinctive element (450) of the vehicle; and
receiving at the central server (2) said univocal distinctive element (450) and checking a presence thereof in a memory.

2. The method, as per claim 1, wherein in case of a check with positive result the central server orders a payment consensus.

3. The method, as per claim 1, wherein said univocal distinctive element is a plate of the vehicle, or a part thereof.

4. The method, as per claim 1, wherein said image acquisition device (100) is positioned only at an access gate or at the access gate and an exit gate from the area or section to be covered with said paid admission.

5. The method, as per claim 1, wherein said image acquisition device is univocally identified to allow to detecting a specific geographic area where said image acquisition device is positioned.

6. The method, as per one claim 1, wherein said image acquisition device is connected to a local server which is communicating with the central server.

7. The method, as per claim 1, further comprising a preliminary step of connecting to the central server (2) to make a registration by inserting an identification code (C.I.) associated with the vehicle, the identification code being kept in the memory in the central server.

8. The method, as per claim 2, further comprising the step of transiting the vehicle and causing the central server (2) to receive said univocal distinctive element (450), before payment authorization, wherein the central server connects to an external device (1) sending a request for insertion of an authorization code (C.A.).

9. The method, as per claim 8, wherein, following reception by the central server of said authorization code (C.A.), the central server checks correctness of the received authorization code, comparing the received authorization code with the authorization code stored in the memory and, in case of positive result, proceeds with the payment consensus.

10. An assembly for making a payment during access of a vehicle to an area or section requiring paid admission, said assembly comprising:
a central server (2) adapted to receive and memorize an identification code (C.I.) associated to the vehicle, said identification code being a univocal distinctive element (450) of the vehicle; and
an image acquisition device (100) adapted for image acquisition (400) of said univocal distinctive element (450) of the vehicle;
wherein the assembly is configured so that said univocal distinctive element (450) of the vehicle, once acquired by the image acquisition device, is transmitted to the central server (2), which is programmed to check a presence of said univocal distinctive element in a memory of the central server.

11. The method, as per claim 1, further comprising the step of inserting an additional authorization code (C.A.) that is associated to the identification code (C.I.).
